(19) United States
(12) Patent Application Publication
(10) Pub. No.: US 2007/0245631 A1
(43) Pub. Date: Oct. 25, 2007

(54) Easy-Lock Foldable Safty Window

(76) Inventor: Na Hyong Yi, Paju-Si (KR)

Correspondence Address: IPLA P.A., 3580 WILSHIRE BLVD., 17TH FLOOR, LOS ANGELES, CA, 90010, US

(21) Appl. No.: 11/574,226

(22) PCT Filed: Aug. 25, 2005
(86) PCT No.: PCT/KR05/02808

§ 371 Date: Feb. 23, 2007

(30) Foreign Application Priority Data
Aug. 25, 2004 (KR) 10-2004-0067043

(51) Int. Cl. E06B 5/11

(52) U.S. Cl. 49/55

(57) ABSTRACT

Disclosed herein is a folding security window, in which an end of the security window is mounted to a window sill, the other end of the security window is connected to a window, a height-adjustable movable part is mounted to a vertical pole of the security window, a connecting means for connecting or disconnecting the security window to or from the window is provided, and the folded security window is not exposed to the outside. When the window is opened or closed, the security window is unfolded or folded, so that the security window does not spoil the appearance of the city. The movable parts mounted to upper and lower ends of the vertical pole enhance the adaptability and movability of the security window. The security window efficiently performs its original function without hindering ventilation, views, or light admittance.

### TECHNICAL FIELD

The present invention relates, in general, to a folding security window installed on a sliding window frame and, more particularly, to a folding security window capable of easily being locked and unlocked, which is constructed so that height-adjustable movable parts are inserted into upper and lower ends of vertical poles of the security window, and links connecting spaced vertical poles to each other are received in the vertical poles when the security window is folded, and the security window is easily connected to and disconnected from a general window, thus allowing the security window to be rapidly detached from the general window when a disaster or an emergency occurs or the security window is not in use.

### BACKGROUND ART

Generally, many windows are mounted to outer walls of houses, apartments, shopping centers, and multi-use buildings, and function to replenish indoor air, in addition to providing a view and admitting light.

Among various types of windows, a sliding window is most widely used. The sliding window is designed such that a pair of panes is inserted into a rectangular frame, and a locking unit is mounted to opposing ends of the panes.

The window may be used as a passage for coupling the interior of a room to the exterior thereof. In the summer season, especially the hot season, the window is opened. However, in this case, a stranger may easily break into a house through the window, so theft and robbery are somewhat common.

Recently, because theft using windows is common, an additional security window is usually mounted to the window. A folding security window and a fixed net-type security window are widely used as the security window. The folding security window includes a plurality of vertical poles and links. The net-type security window is designed such that bent pipes are continuously connected to cross each other.

However, the conventional security windows are problematic in that they are directly mounted to the front of a window sill, thus marring the appearance of houses and cities. Further, the conventional security windows have a complex structure, so that it is difficult to ensure an outside view, and ventilating efficiency is low. Particularly, since the conventional security windows are directly mounted to a window sill, people cannot rapidly evacuate a room due to the fixed security window when they must escape through the window in the case of an emergency, such as a fire. Thereby, the conventional security windows may harm people.

### DISCLOSURE OF INVENTION

Technical Problem

Accordingly, the present invention has been made keeping in mind the above problems occurring in the prior art, and an object of the present invention is to provide a folding security window, which is constructed so that the folding security window is not always mounted to the front of a window, unlike the prior art, but an end of the folding security window is mounted to a window sill, the other end of the security window is connected to the window, a height-adjustable movable part is mounted to a vertical pole of the security window, a connecting means for connecting or disconnecting the security window to or from the window is provided, and the folded security window is not exposed to the outside.

When the window is opened or closed, the security window is unfolded or folded, so that the security window does not spoil the appearance of a structure or the city. The movable parts mounted to upper and lower ends of the vertical pole enhance the adaptability and movability of the security window. Since the security window is easily connected to or disconnected from the window, it is possible to rapidly detach the security window from the window when necessary, so that it is very convenient to use.

Therefore, the present invention provides a folding security window capable of easily being locked or unlocked, which efficiently performs its original function without hindering ventilation, views, or light admittance.

Hereinafter, the preferred embodiments of the present invention will be described.

FIG. 1 is a perspective view of a security window, according to the present invention, FIG. 2 is a sectional view of the security window, according to the present invention, when the security window is unfolded, FIG. 3 is a sectional view of the security window, according to the present invention, when the security window is folded, FIG. 4 is an enlarged sectional view to show the lower portion of a vertical pole of the security window, according to the present invention, and FIG. 5 is a perspective view to show an important part of a connecting unit of the security window, according to the present invention.

A known folding security window 10 includes a plurality of vertical poles 1 and 1′, and a plurality of links 3 and 3′ which connect the vertical poles 1 and 1′ to each other.

Each of the vertical poles 1 and 1′ has the shape of a rectangular pipe. Slots 2 and 2′ are formed in both surfaces of each vertical pole 1, 1′ having the shape of the rectangular pipe. The links 3 and 3′ are inserted into the vertical poles 1 and 1′ through the slots 2 and 2′.

Movable parts 5 and 5′ having moving rollers 4 and 4′ are inserted into the upper and lower ends of the vertical poles 1 and 1′. A plurality of support holes 6 and 6′ is formed in the movable parts 5 and 5′. The movable part 5, 5′ is secured to the vertical pole 1, 1′ by inserting a support pin 7 into an associated support hole 6, 6′.

A metal piece 8 is provided on an upper portion of the vertical pole 1, which is located at one end of the security window. The metal piece 8 is attached to a corresponding connecting magnet 21 which is attached to a window frame 20. A connecting unit 30 is provided on a lower portion of the vertical pole 1 to connect or disconnect the security window to or from the window frame 20.

The vertical pole 1′, which is located at the other end of the security window, is secured to an inner surface of a window sill 100. Thus, as the window frame 20 is opened or closed, the security window 10 is unfolded or folded.

Further, according to another example of a moving and height-adjusting means for the vertical poles 1 and 1′, moving bars 42 and 42′ are provided on upper and lower portions of the vertical poles 1 and 1′ and are spaced apart from each other. The upper and lower ends of the vertical poles 1 and 1′ are inserted into the moving bars 42 and 42′.

A support body 40 having an insertion hole 41 is provided on an upper end of the vertical pole 1, 1′, so that the moving bar 42 is inserted into the insertion hole 41.

Another insertion hole 41′ is formed in the lower end of each of the vertical poles 1 and 1′, so that another moving bar 42′ is inserted into the insertion hole 41′. Thus, the vertical poles 1 and 1′ can be easily unfolded or folded along the moving bars 42 and 42′. The support body 40 inserted into the upper end of each of the vertical poles 1 and 1′ may be freely moved up and down. Thus, by adjusting the height at which the upper moving bar 42 is secured, the height of the security window can be adjusted.

Brackets 43 and 43′ are provided on ends of the moving bars 42 and 42′ to be mounted to the window sill 100. Thus, the security window is mounted to the window sill 100 using the brackets 43 and 43′.

The connecting unit 30 includes a support part 31 provided at a predetermined position on the lower end of the vertical bar 1. A support bar 32 is inserted into the support part 31 in such a way as to be movable up and down. A seating hole 101 is formed at a predetermined position in the window sill 100. Further, a connecting part 33 is provided on the lower portion of the window frame 20, and has a connecting hole 34 so that the upper end of the support bar 32 is inserted into the connecting hole 34 of the connecting part 33.

A support magnet 35 secured to the window frame 20 is provided at a predetermined position on the support part 31. Thus, as the support bar 32 moves up and down, the support part is connected to or disconnected from the connecting part 33. Thereby, the security window is connected to or disconnected from a window.

The construction of a connecting unit according to another embodiment of the present invention will be described below. A connecting part 33 having a connecting hole 34 protrudes from the lower portion of the vertical pole 1 which is located at one end of the security window. A conventional locking unit 37 having a rotary elevating part 36 is mounted to the lower portion of the window frame 20. Thus, as the rotary elevating part 36 moves up and down, the locking unit is connected to or disconnected from the connecting part 33. Thereby, the security window is connected to or disconnected from the window.

Further, an additional connecting pole 39 having a plurality of rotary hooks 38 may be mounted to one end of the window frame 20. Hook holes 38′ are formed in the vertical pole 1 at positions corresponding to the rotary hooks 38. Thus, by adjusting the rotary hooks 38, the security window is connected to or disconnected from the window.

The security window 10 may be directly installed in the window sill 100 so that the vertical poles 1 and 1′ provided on both ends of the security window 10 are directly secured to the window frame 20 and the window sill 100. In such a state, the security window 10 is folded or unfolded.

Further, an additional security window frame 22 may be formed. In this case, a vertical pole 1′ provided on one end of the security window 10 is secured in the security window frame 22. In such a state, the security window frame 22 is mounted to one end of the window sill 100. A vertical pole 1 provided on the other end of the security window 10 installed in the security window frame 22 is detachably connected to one end of the window frame 20 using the connecting unit 30.

The operation of the folding security window capable of easily being locked and unlocked, according to the present invention, will be described in detail with reference to the accompanying drawings.

As shown in the drawings, the security window of this invention includes a plurality of vertical poles 1 and 1′, and a plurality of folding links 3 and 3′ which connect the vertical poles 1 and 1′ to each other. As the vertical poles 1 and 1′ are spaced apart from each other, the links 3 and 3′ unfold, so that the security window is opened. Conversely, when the vertical poles 1 and 1′ approach each other, the links 3 and 3′ are rotated to be vertical, so that the security window 10 folds.

In this case, the vertical pole 1 provided at one end of the security window is directly connected to one end of the window frame 20, and the vertical pole 1′ provided at the other end of the security window is secured to the inner surface of the window sill 100. Thereby, the security window 10 unfolds or folds as the window frame 20 is opened or closed.

Unlike the prior art, the security window is not secured to the entire surface of the window frame, and is unfolded when the window is opened.

Particularly, when the security window 10 is folded, the links 3 and 3′ are not exposed to the outside, but are completely inserted into the vertical poles 1 and 1′ so that they are not observed from the exterior. Each of the vertical poles 1 and 1′ has the shape of a rectangular pipe. The slots 2 and 2′ are formed in both sides of each vertical pole 1, 1′ having the shape of the rectangular pipe, and ends of the links 3 and 3′ are inserted into the vertical poles 1 and 1′ through the slots 2 and 2′. That is, the links 3 and 3′ are rotated and folded to be inserted into the vertical poles 1 and 1′.

Since the security window must be frequently unfolded or folded when the window is opened or closed, the movable parts 5 and 5′ are mounted to the upper and lower ends of the vertical poles 1 and 1′, thus allowing the security window to more smoothly move.

The movable parts 5 and 5′ have on the lower ends thereof the moving rollers 4 and 4′. Since the moving rollers 4 and 4′ rotate and move along a rail (not shown), the sliding motion of the vertical poles 1 and 1′ is very easy. The height of each of the moving parts 5 and 5′ is adjustable from the end of each of the vertical poles 1 and 1′. Thus, the security window of this invention is easily adapted to various sizes of windows.

A plurality of support holes 6 and 6′ is laterally formed in the movable parts 5 and 5′ inserted into ends of the vertical poles 1 and 1′ each having the shape of the rectangular pipe. By inserting the support pin 7 into an associated support hole, the movable parts 5 and 5′ are secured to the vertical poles 1 and 1′. According to the height of the support hole 6, 6′ into which the support pin 7 is inserted so as to support the movable part 5, 5′, the overall height of the security window 10 is changed. Thus, even if the height of a window is slightly different from a preset height, it is possible to apply the security window 10 to various windows by adjusting the height of the movable part 5, 5′ without manufacturing the vertical poles 1 and 1′ again.

Further, the vertical pole 1 provided at one end of the security window is secured to one end of the window frame 20, so that the security window folds or unfolds as the window frame 20 is closed or opened. The metal piece 8 is provided on the upper end of the vertical pole 1, and the connecting magnet 21 is provided on the window frame 20 at a position corresponding to the metal piece 8. Thereby, the metal piece 8 is attached to the connecting magnet 21 by an attractive force.

The connecting unit 30 is provided on the lower end of the vertical pole 1 to connect the security window to the window. Thus, as the window frame 20 is opened or closed, the security window 10 is unfolded or folded together with the window frame.

Particularly, when the security window 10 is not in use or people must escape through a window because of an emergency, such as a fire, the security window 10 may be separated from the window frame 20. The separated security window 10 is folded and secured to one side, so that it is possible to completely open the window.

To this end, the connecting unit 30 is detached from the window. As shown in FIG. 6, the connecting unit 30 includes the support part 31 mounted to one end of the vertical pole 1. The support bar 32 is inserted into the support part 31 in such a way as to move up and down. The connecting part 33 having the connecting hole 34 is provided above the support bar 32, and is secured to the window frame 20. When the support bar 32 moves up to be inserted into the connecting hole 34 of the connecting part 33, the security window 10 is connected to the window frame 20. Conversely, when the support bar 32 moves down to be removed from the connecting hole 34, the security window 10 is separated from the window frame 20.

In this case, the support bar 32 is freely movable up and down without an additional support means. When the support bar 32 moves along the window sill 100, the length of the support bar 32 is adjusted so that the support bar 32 is inserted into the connecting hole 34 of the connecting part 33. Meanwhile, when the support bar 32 moves to one side of the window sill 100 and is positioned in the seating hole 100′ formed in the window sill 100, the support bar 32 moves down to be removed from the connecting hole 34. Thereby, the security window 10 is separated from the window frame 20.

Even when the security window 10 is folded, there are cases where the support bar 32 must not move down, in order to maintain connection between the security window and the window. To this end, the support magnet 35 is provided on one side of the support part 31 to be secured to the window frame 20, so that the support magnet 35 supports the support bar 32 using a predetermined attractive force. Thus, only when the support bar 32 moves down, the connecting force of the support bar 32 is released so that the security window 10 is separated from the window frame 20.

The connecting unit 30 may comprise the conventional locking unit 37, as shown in FIG. 6. The conventional locking unit 37 has the rotary elevating part 36 therein. The locking unit 37 is mounted to the window frame 20, and the connecting part 33 having the connecting hole 34 is provided above the rotary elevating part 36 and is secured to one side of the vertical pole 1. Thereby, when the rotary elevating part 36 is forced to move up, the rotary elevating part 36 is connected to the connecting part 33, so that the security window 10 is connected to the window frame 20. Conversely, when the rotary elevating part 36 moves down, the security window 10 is separated from the window frame 20.

Further, the connecting unit 30 may be provided on the additional connecting pole 39, as shown in FIG. 10. A plurality of rotary hooks 38 protrudes from the connecting pole 39, and a plurality of hook holes 38′ is formed in the vertical pole 1 at positions corresponding to the rotary hooks 38. When the rotary hooks 38 of the connecting pole 39 rotate to be inserted into the hook holes 38′ of the vertical pole 1, the security window 10 is connected to the window frame 20. Meanwhile, when the rotary hooks 38 rotate upward to be removed from the hook holes 38′, the security window 10 is removed from the window frame 20.

The operation of the security window according to the present invention will be described with reference to FIGS. 7 to 9. When the security window 10 is connected to the window frame 20, the security window 10 is unfolded or folded as the window is opened or closed, as shown in FIG. 7. When the connecting unit 30 of FIG. 8 is released and thereafter the window is opened, the security window 10 maintains a folding state and only the window is opened, as shown in FIG. 9. Thus, it is more convenient to use the security window.

Particularly, a storage recess (not shown) may be formed in one side of the window frame 20 to receive the folded security window 10. In this case, the folded security window 10 is not exposed to the outside, thus providing a good appearance without affecting the original functions of the window, such as ventilation, a view, or light admittance.

Further, as shown in FIG. 11, the additional rectangular security window frame 22 may be formed. After one vertical pole 1′ of the security window 10 is secured to one end of the rectangular security window frame 22, the security window frame 22 is mounted to the window sill 100 which has been already installed, and another vertical pole 1 is connected to the window frame 20. Such a construction allows the security window 10 to be more easily installed, and allows the window to be completely closed when the security window 10 is separated from the window frame 20.

Further, as shown in FIG. 12, the moving bars 42 and 42′ are provided on the upper and lower ends of the vertical poles 1 and 1′ of the security window 10 in such a way as to be spaced apart from each other. The upper and lower ends of the vertical poles 1 and 1′ are inserted into the moving bars 42 and 42′.

In this case, the movable support body 40 is inserted into the upper end of each of the vertical poles 1 and 1′. When the moving bar 42 is inserted into the insertion holes 41 in the support bodies 40, the support bodies 40 inserted into the vertical poles 1 are simultaneously extended from or retracted into the vertical poles by the vertical motion of the moving bar 42. In this way, the overall height of the security window 10 is adjustable.

Another insertion hole 41′ is directly formed in the lower end of each of the vertical poles 1 and 1′. Thus, when the moving bar 42′ disposed at a lower position is inserted into the insertion holes 41′, the vertical poles 1 and 1′ are easily unfolded or folded along the moving bar 42′.

Such a security window 10 is mounted to a side surface of the window sill 100 using the brackets 43 and 43′ provided at ends of the moving bars 42 and 42′. Afterwards, one vertical pole 1 is connected to the window frame 20 via the connecting unit 30, as in the above-mentioned embodiments. Another vertical pole 1′ is secured to a vertical side surface of the window sill 100. Thus, as the window frame 20 is opened or closed, the security window 10 is easily unfolded or folded.

Therefore, the security window of the present invention is characterized in that it is very efficient, and is universally usable.

Advantageous Effects

As described above, the present invention provides a folding security window capable of easily being locked and unlocked, which is constructed so that, when a window is opened or closed, the security window is unfolded or folded, so that the security window does not spoil the appearance of a structure or the city. Movable parts mounted to upper and lower ends of the vertical pole enhance the adaptability and movability of the security window. Since the security window is easily connected to or disconnected from the window, it is possible to rapidly detach the security window from the window when necessary, so that it is very convenient to use.

Further, the present invention provides a folding security window capable of easily being locked or unlocked, which efficiently performs its original function without hindering ventilation, views, or light admittance.

### BRIEF DESCRIPTION OF THE DRAWINGS

FIG. 1 is a perspective view of a security window, according to the present invention;

FIG. 2 is a sectional view of the security window, according to the present invention, when the security window is unfolded;

FIG. 3 is a sectional view of the security window, according to the present invention, when the security window is folded;

FIG. 4 is an enlarged sectional view to show the lower portion of a vertical pole of the security window, according to the present invention;

FIG. 5 is a perspective view to show an important part of a connecting unit of the security window, according to the present invention;

FIG. 6 is a perspective view to show another embodiment of a connecting unit of the security window, according to the present invention;

FIG. 7 is a view to show the state where a window is connected to the security window of this invention and is open;

FIG. 8 is a view to show the state where the window is connected to the security window of this invention and is closed;

FIG. 9 is a view to show the state where the window is disconnected from the security window of this invention and is open;

FIG. 10 is a view to show a further embodiment of a connecting unit for connecting the window to the security window, according to the present invention;

FIG. 11 is a perspective view to show the state where the security window of this invention is installed in an additional frame and mounted to a window sill; and

FIG. 12 is a view to show another embodiment of a security window, according to the present invention.

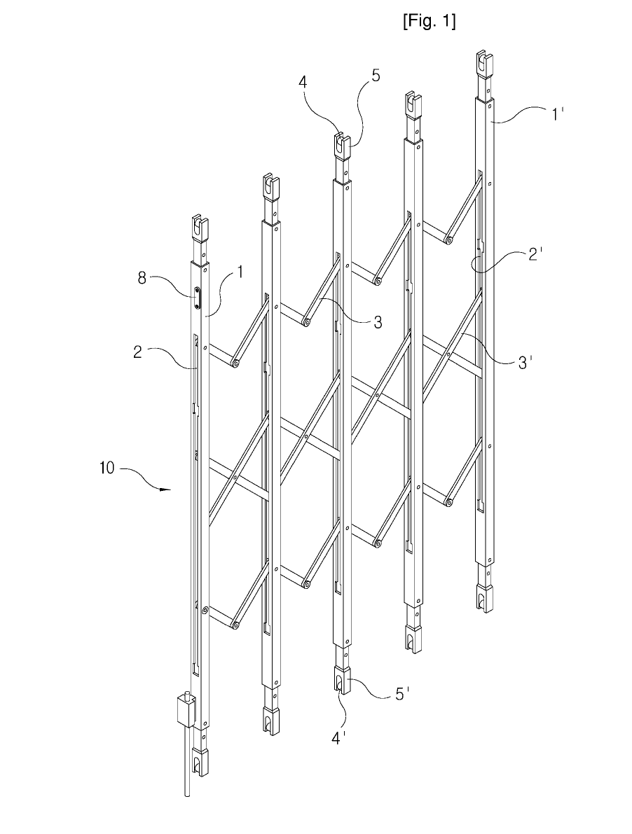

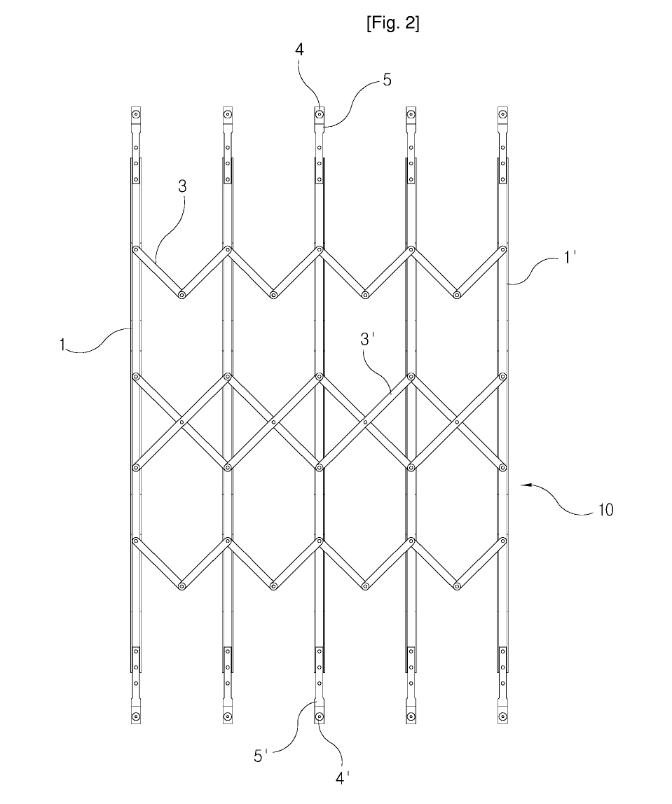

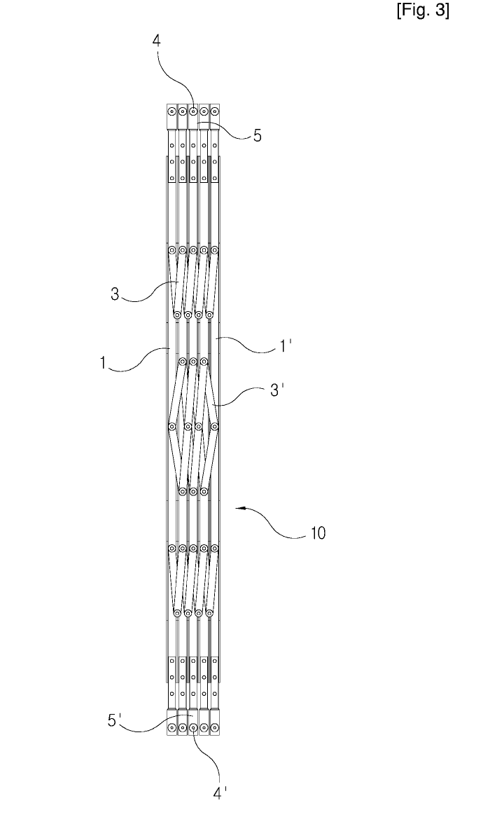

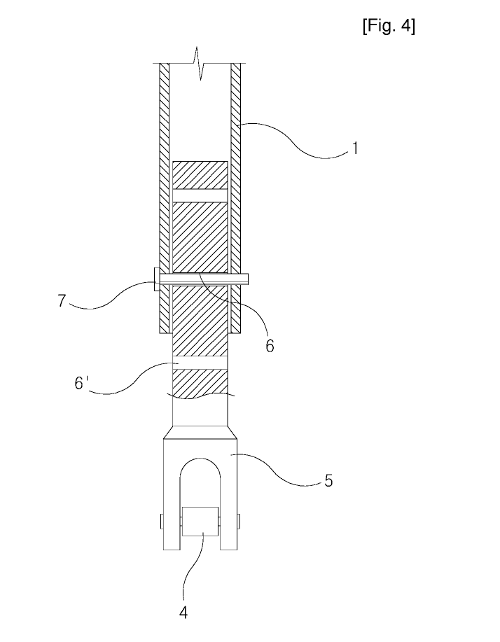

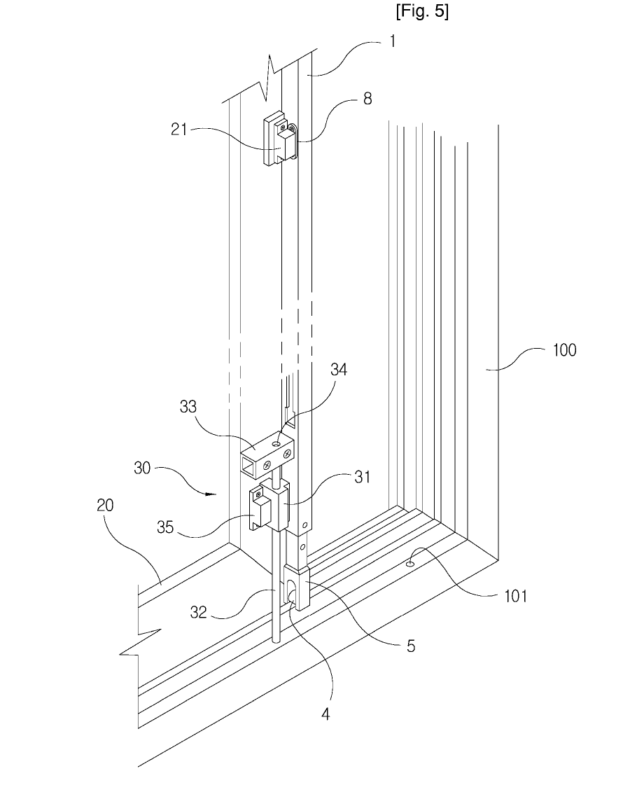

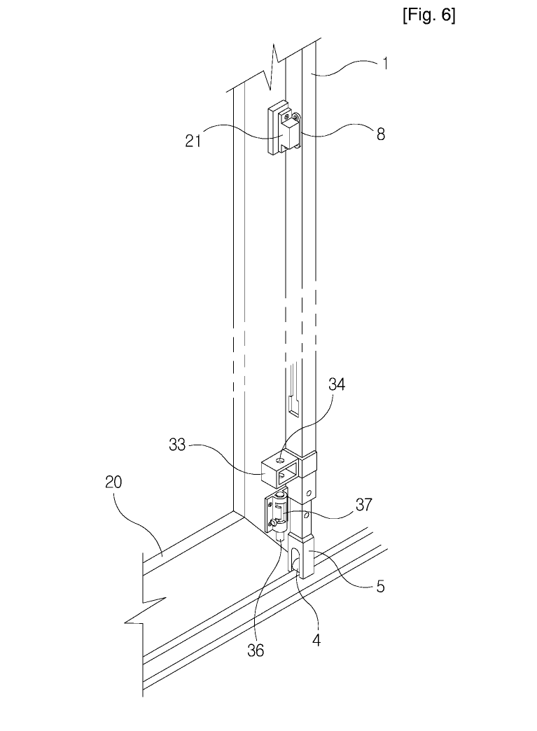

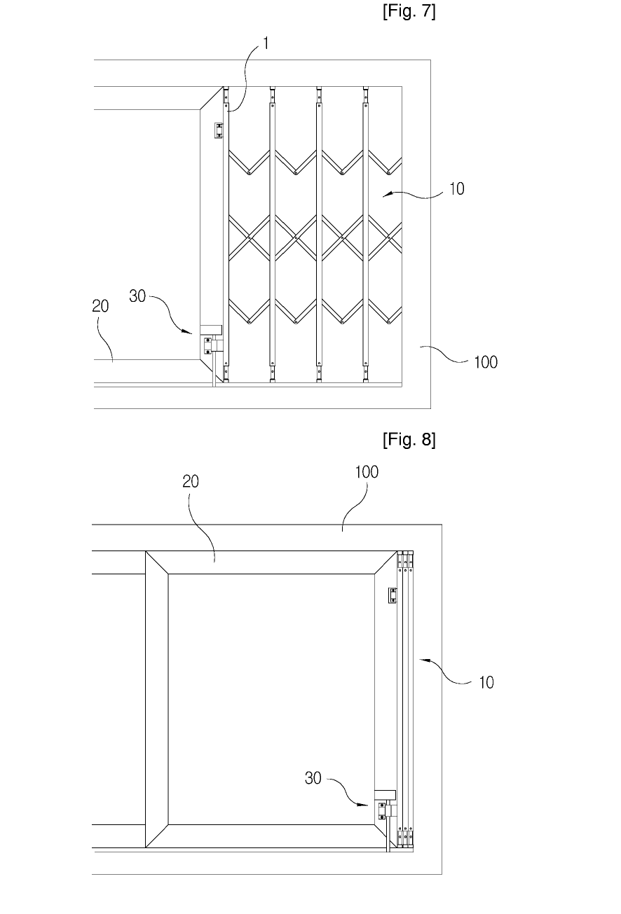

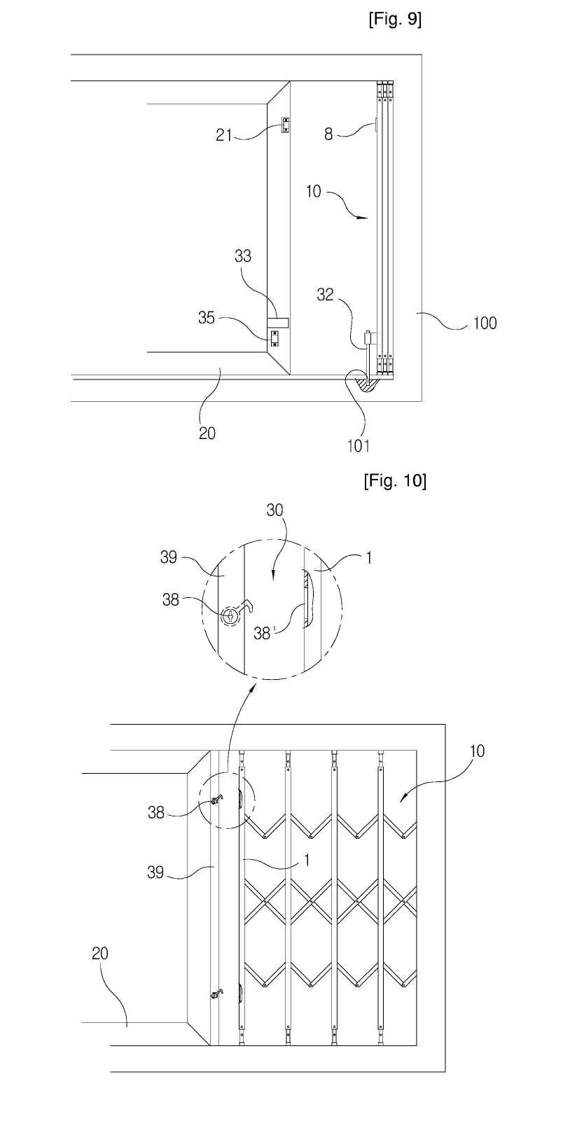

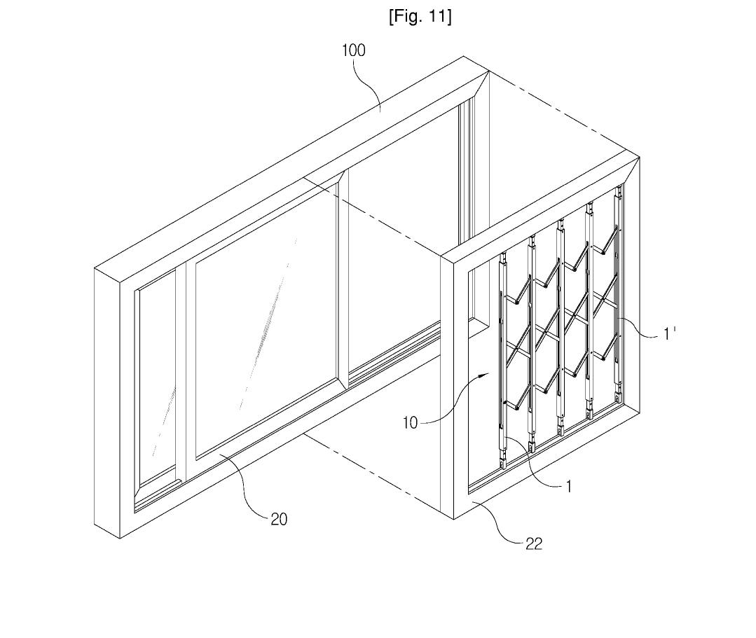

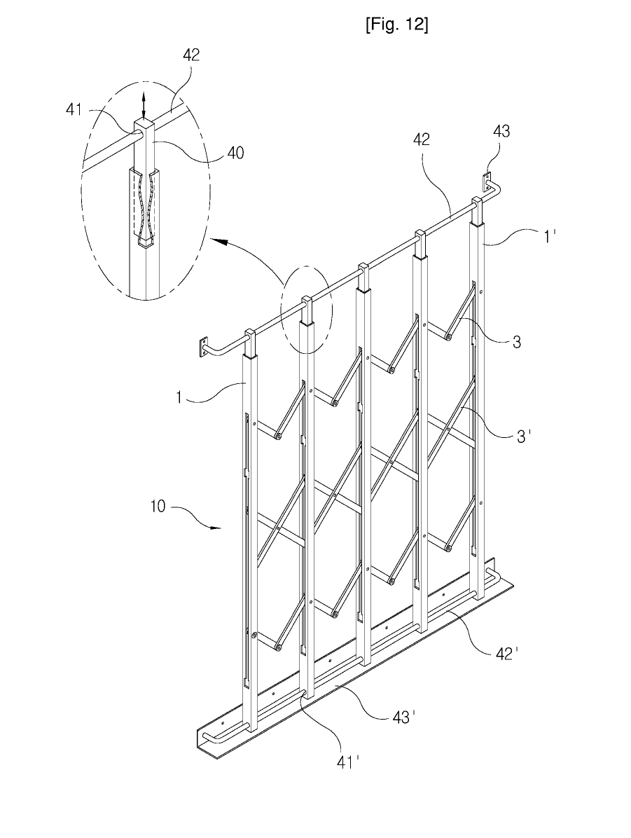

### DESCRIPTION OF REFERENCE CHARACTERS OF IMPORTANT PARTS

1, 1′: vertical poles 2, 2′: slots
3, 3′: links 4, 4′: moving rollers
5, 5′: movable parts 6, 6′: support holes
7: support pin 8: metal piece
10: security window
20: window frame 21: connecting magnet
22: security window frame
30: connecting unit 31: support part
32: support bar 33: connecting body
34: connecting hole 35: support magnet
36: rotary elevating part 37: locking unit
38: rotary hooks 38′: hook holes
39: connecting pole
40: support body 41, 41′: insertion holes
42, 42′: moving bars 43, 43′: brackets
100: window sill 101: seating hole

1. A folding security window capable of easily being locked and unlocked, having a plurality of vertical poles (1)(1′), and a plurality of links (3)(3′) to connect the vertical poles (1)(1′) to each other,
wherein each of the vertical poles (1)(1′) has a shape of a rectangular pipe, slots (2)(2′) are formed in both sides of each of the rectangular pipe-shaped vertical poles (1)(1′), the links (3)(3′) are inserted into the vertical poles (1)(1′) through the slots (2)(2′), and pole moving and height adjusting means is provided on each of upper and lower ends of the vertical poles (1)(1′) to allow the vertical poles (1)(1′) to be easily folded, in addition to adjusting height of the vertical poles (1)(1′),
a metal piece (8) is provided on an upper portion of a vertical pole (1) provided at a first end of the security window, and is attached to a connecting magnet (21) provided on a window frame (20), and a connecting unit (30) is provided on a lower portion of the vertical pole (1) to connect or disconnect the vertical pole (1) to or from the window frame (20), and
another vertical pole (1′) provided at a second end of the security window is secured to an inner surface of a window sill (100), so that the security window (10) is folded or unfolded when the window frame (20) is closed or opened.

2. The folding security window according to claim 1, wherein the pole moving and height adjusting means comprises:
a movable part (5)(5′) provided on each of the upper and lower ends of the vertical poles (1)(1′), and having a moving roller (4)(4′);
a plurality of support holes (6)(6′) formed in the movable part (5)(5′); and
a support pin (7) inserted into an associated support hole to secure the movable part to the vertical pole (1)(1′).

3. The folding security window according to claim 1, wherein the pole moving and height adjusting means comprises:
moving bars (42)(42′) provided on upper and lower portions of the vertical poles (1)(1′) and spaced apart from each other, the upper and lower ends of the vertical poles (1)(1′) being inserted into the moving bars;
a support body (40) inserted into the upper end of each of the vertical poles (1)(1′), and having a first insertion hole (41) so that one moving bar (42) is inserted into the first insertion hole (41); and
a second insertion hole (41′) formed in the lower end of each of the vertical poles (1)(1′) so that the remaining moving bar (42′) is inserted into the second insertion hole (41′).

4. The folding security window according to claim 1, wherein the connecting unit (30) comprises:
a support part (31) provided at a predetermined position on the lower end of the vertical pole (1) located on the first end of the security window;
a support bar (32) inserted into the support part (31) in such a way as to move up and down;
a seating hole (101) formed in a predetermined portion of the window sill (100);
a connecting part (33) provided at a predetermined position on a lower portion of the window frame (20), and having a connecting hole (34) such that an upper end of the support bar (32) is inserted into the connecting hole; and
a support magnet (35) provided on a side of the support part (31) and secured to the window frame (20), so that the support part is attached to or detached from the connecting part (33) as the support bar (32) moves up and down.

5. The folding security window according to claim 1, wherein the connecting unit (30) comprises:
a connecting part (33) protruding from the lower end of the vertical pole (1) located at the first end of the security window, and having a connecting hole (34);
a locking unit (37) mounted to a lower end of the window frame (20), and having a rotary elevating part (36), so that the locking unit is connected to or disconnected from the connecting part (33) according to a height of the rotary elevating part (36) which moves up and down.

6. The folding security window according to claim 1, wherein the connecting unit (30) comprises:
a connecting pole (39) mounted to a first side surface of the window frame (20), and having a plurality of rotary hooks (38);
hook holes (38′) formed in the vertical pole (1) at positions corresponding to the rotary hooks (38), so that a window is connected to or disconnected from the security window according to positions of the rotary hooks (38).

7. The folding security window according to claim 1, wherein the security window (10) is installed on the window sill (100), and the vertical poles (1)(1′) provided on both ends of the security window are secured to the window frame (20) and the window sill (100), so that the security window is folded or unfolded as the window frame (20) is closed or opened.

8. The folding security window according to claim 1, wherein a rectangular security window frame (22) is additionally provided, the vertical pole (1′) provided at a first end of the security window (10) is secured to an inner surface of the security window frame (22), the security window frame (22) is secured to a surface of the window sill (100), and a vertical pole (1) provided at a second end of the security window (10) is connected to a surface of the window frame (20), so that the security window is unfolded or folded as the window frame (20) is opened or closed.
